(19) United States
(12) Patent Application Publication
(10) Pub. No.: US 2002/0170809 A1
(43) Pub. Date: Nov. 21, 2002

(54) Thermal dissipating switch pad for backlit control

(76) Inventor: Chris Ralph Snider, El Paso, TX (US)

Correspondence Address: JIMMY L. FUNKE, DELPHI TECHNOLOGIES, INC., Legal Staff, Mail Code: A-107, P.O. Box 9005, Kokomo, IN, 46904-9005, US

(21) Appl. No.: 09/861,500

(22) Filed: May 21, 2001

(51) Int. Cl. G01D 13/26

(52) U.S. Cl. 200/56 R

(57) ABSTRACT

A switch pad constructed of a thermally conductive elastomer whereby undesirable heat generated by an incandescent lamp used to backlight the device. A thermally conductive elastomer is molded into all or a portion of the switch pad and conducts heat away from the surface of the backlit device.

### TECHNICAL FIELD

The present invention relates to control panels that require incandescent lamps for backlighting and more particularly to a thermal dissipating switch pad for back lit control.

### BACKGROUND OF THE INVENTION

Control panels typically have devices such as buttons or switches that require incandescent lamps for backlighting in order to ensure visibility in dark conditions. However, the lamps also generate heat, which can cause undesirable side effects in many applications.

It is generally desirable to vent the heat generated by an incandescent lamp through strategically placed air gaps. However incandescent lamps used for backlighting are usually positioned in areas of the control panel that must be sealed. Therefore, heat cannot be vented through gaps, etc. in the control panel because the light will leak out any gap, creating an undesirable visual condition. Sealing the control panel will cause the heat generated by the lamp to be restricted within the control panel and ultimately heat up the surface of the device making it hot to the touch, or possibly causing premature failure.

### SUMMARY OF THE INVENTION

The present invention is a method and device for dissipating heat from a device having backlit control. According to the present invention, a portion of the backlit device, such as a switch pad, is fashioned from a thermally conductive elastomer that is capable of dissipating heat. The undesirable heat generated by the incandescent lamp is transferred through the thermally conductive elastomer and away from the surface of the device, allowing the device to be properly sealed from leaking light.

It is an object of the present invention to dissipate the heat generated by an incandescent lamp used to backlight a device of a control panel. It as another object of the present invention to provide a device having a thermal elastomer therein to dissipate heat. It is yet another object of the present invention to provide a device having a thermal elastomer insert molded therein to dissipate heat from an incandescent lamp used to backlight the device.

Other objects and features of the present invention will become apparent when viewed in light of the detailed description of the preferred embodiments and when taken in conjunction with the attached drawings and appended claims.

### BRIEF DESCRIPTION OF THE DRAWINGS

In order that the present invention may be well understood, there will now be described some embodiments thereof, given by way of example, with reference to the accompanying drawings, in which:

FIG. 1 is a front view of a backlit “rocker” pushbutton switch;

FIG. 2 cross-sectional side view of a switch having a thermal dissipating switch pad according to the present invention; and

FIG. 3 is a front view of the switch pad according to the present invention.

### DESCRIPTION OF THE PREFERRED EMBODIMENT

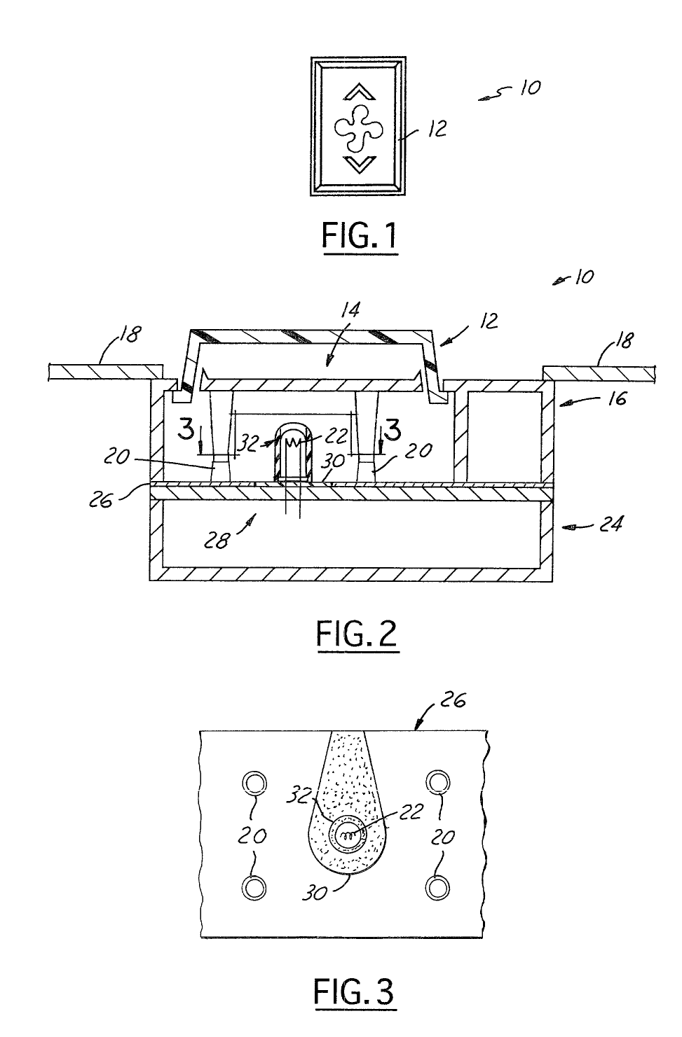

The present invention is a device and method for dissipating heat in a backlit device used in a control panel. The present invention will be described herein with reference to a switch typically used in a control panel and having an incandescent lamp for illuminating the surface of the device in dark lighting conditions. FIG. 1 is one example of such a switch. The figure shows a front view of a backlit rocker-type pushbutton switch 10. It should be noted however that many applications of the present invention are possible and one skilled in the art is capable of applying the present invention to a variety of devices and backlit applications that are too numerous to mention herein.

FIG. 2 is a cross-sectional side view of the switch, or device 10, having thermal dissipation capability according to the present invention. The switch 10 has a pushbutton 12 that is used to activate an actuator 14. The switch 10 typically has a faceplate 16 that is mounted on the surface of a control panel 18. Switch domes 20 are used to activate the switch through actuation of the actuator 14. An incandescent lamp 22 is used to illuminate the surface of the pushbutton 12. The switch 10 is generally disposed within a housing 24 or case.

A switch pad 26 of the present invention provides a base for the switch domes 20 and the lamp 22. The switch pad 26 is located within the housing 24. According to the present invention, the switch pad 26 has a thermally conducting elastomer molded therein that conducts heat generated by the incandescent lamp 22 away from the surface of the pushbutton 12 so the heat can be dissipated in another area. In the embodiment shown in FIG. 2, the housing 24 has an open area 28 behind the switch pad 26 which draws the heat dissipated from the switch pad 26 away from the surface of the pushbutton 12.

According to the present invention, there is no need for air gaps or vent holes that are usually required to alleviate the heat loading that occurs around the lamp. By dissipating the heat load according to the present invention, the touchable surfaces of devices used on the control panel remain cool to the touch, without unsightly gaps for light to leak through. The present invention also allows for the use of lower temperature capable materials in the design and manufacture of devices, thereby reducing the cost of these devices. Design flexibility is also enjoyed because there is no longer a need to work air gaps, vent holes, or other undesirable features into the placement of the devices in the control panel to release heat. The heat can be conducted away from the area of the device and dissipated from the control panel in a far less conspicuous way.

The entire switch pad 26 may be molded from the thermally conductive elastomer. It is also possible to insert mold, or co-mold, a portion of the switch pad 26 from the thermally conductive elastomer. FIG. 3 is a front view of the switch pad 26 of the present invention showing a thermally conductive area 30 surrounding the lamp. The area 30 is made of a thermally conductive material and is molded simultaneously with another material to make up the entire switch pad 26.

In another embodiment, also shown in FIGS. 2 and 3, the lamp 22 is fitted with an optional boot 32. The boot 32 surrounds the lamp 22 and further dissipates heat directly away from the lamp.

According to the present invention, the thermal dissipating switch pad 26 for backlit controls allows the incandescent lamp area to be completely sealed by plastic walls, or located in a restricted area and provide a conductive path for the heat load directly through the switch pad. The heat is conducted away to be dissipated in another, more convenient or less noticeable, area of the control panel. The touchable surfaces that a user may encounter will remain cool to the touch. Also, lower temperature capable materials can be used for the device and its surrounding parts.

While particular embodiments of the invention have been shown and described, numerous variations and alternate embodiments will occur to those skilled in the art. Accordingly, it is intended that the invention be limited only in terms of the appended claims.

What is claimed is:

1. A switch comprising:
a surface member having a predefined pattern for illumination;
an actuator in contact with and below said surface member;
an incandescent lamp for illuminating said predefined pattern on said surface member; and
a switch pad supporting said incandescent lamp, said switch pad having first and second contacts in communication with said actuator, and at least a portion of said switch pad being molded from a thermally dissipating elastomer whereby heat generated by said incandescent lamp is conducted through said thermally dissipating elastomer and away from said surface member.

2. The switch as claimed in claim 1 wherein said switch further comprises a boot made of said thermally dissipating elastomer and said boot surrounding said incandescent lamp.

3. The switch as claimed in claim 1 wherein said at least a portion of said switch pad that is molded from said thermally dissipating elastomer is a predefined area around said incandescent lamp.

4. The switch as claimed in claim 1 wherein said switch is contained in a housing having an opening therebehind for dissipating heat conducted away from said surface member by said thermally dissipating elastomer.

5. The switch as claimed in claim 4 wherein said housing has an upper portion and a lower portion, said upper portion of said housing supporting said actuator and said surface member and said lower portion of said housing having said opening therein, and said switch pad located between said upper and lower portions of said housing.

6. A switch pad comprising:
a base having an incandescent lamp mounted thereto; and
at least a portion of said housing being a thermally conductive elastomer material.

7. The switch pad as claimed in claim 6 further comprising a boot surrounding said incandescent lamp, said boot being made of a thermally conductive elastomer material.

8. The switch pad as claimed in claim 6 wherein said at least a portion of said housing is a predefined area surrounding said incandescent lamp.

9. A method for dissipating heat from the surface of a control panel having at least one backlit device illuminated by an incandescent lamp, said method comprising the steps of:
mounting said incandescent lamp to the backlit device wherein said backlit device has a switch pad having at least a portion thereof molded from a thermally dissipating elastomer;
conducting heat generated by said incandescent lamp through said switch pad away from said backlit device to a location remote from said backlit device; and
dissipating heat conducted away from said backlit device at said remote location.

10. The method as claimed in claim 9 wherein said step of dissipating heat further comprises dissipating heat in a housing located behind said incandescent lamp, said housing having an opening therein.
